(19) United States
(12) Patent Application Publication
(10) Pub. No.: US 2008/0181748 A1
(43) Pub. Date: Jul. 31, 2008

(54) Fastener For Application to a Threaded Stud

(76) Inventors: Frank Rosemann, Munzenberg (DE); Johann Reindl, Biebertal (DE)

Correspondence Address: MILES & STOCKBRIDGE PC, 1751 PINNACLE DRIVE, SUITE 500, MCLEAN, VA, 22102-3833, US

(21) Appl. No.: 11/910,234

(22) PCT Filed: Mar. 30, 2006
(86) PCT No.: PCT/EP06/61162

§ 371 Date: Oct. 1, 2007

(30) Foreign Application Priority Data
Mar. 31, 2005 (DE) 10 2005 015 033.0

(51) Int. Cl. F16B 37/08

(52) U.S. Cl. 411/431; 403/21

(57) ABSTRACT

Disclosed is a fastener (1) for application to a threaded stud (31), having a sleeve-like retaining element (2) with a cavity (5) extending in the direction of its longitudinal axis to accommodate the threaded stud (31) and at least one deformable clamping region that tends to assume a clamping position projecting into the cavity (5) and gripping the threaded stud (31), and having a flange (3) arranged at the forward end of the retaining element (2) in the direction of installation that can be pressed onto an item (32) to be fastened, wherein the flange (3) is arranged a distance away from the retaining element (2) and attached to the retaining element (1) by means of spring shackles (4).

The invention concerns a fastener for application to a threaded stud, having a sleeve-like retaining element with a cavity extending in the direction of its longitudinal axis to accommodate the threaded stud and at least one deformable clamping region that tends to assume a clamping position projecting into the cavity and gripping the threaded stud, and having a flange arranged at the forward end of the retaining element in the direction of installation that can be pressed onto an item to be fastened.

Fasteners of the specified type are used particularly in automobile manufacture to fasten parts to threaded studs. The distinguishing feature of these fasteners is that they can be brought into the fastening position on a threaded stud and securely attached to the threaded stud solely through an axial motion. The connection can be released again by unscrewing the fastener from the threaded stud like a nut. Moreover, it is possible to increase the axial clamping force of an established connection by turning the fastener in the direction of tightening.

In a fastener of the specified type known from DE 101 33 063 A1, the retaining element has a polygonal cross-section and its wall has radially resilient wall sections that deform radially outward when the retaining element is pushed onto the threaded stud. A clamping sleeve is formed onto one end of the clamping element such that it can break off and its inner cross-section is dimensioned such that it can be pushed over the outside of the retaining element, whereby the radially resilient wall sections are deformed inward such that the threads of the threaded stud can be partially formed into the resilient wall sections. A flange is affixed directly to the retaining element. With this fastener, multiple assembly steps and tools are required in order to fasten an article.

From JP 61-79018 is known a fastener for fastening a component to a threaded stud, which has a sleeve-like retaining element provided with longitudinal slots, with resilient retaining fingers arranged in the slots for gripping the threaded stud, and has a flange that can be placed on the component. Arranged at the forward end of the retaining element in the direction of installation are angled clips whose ends extend radially outward at a distance from the flange. With the aid of the clips, the fastener can be preinstalled on the component to be fastened, with the clips engaging around the inner edge of an assembly opening. For final assembly, the component with the preinstalled fastener can be pressed onto the threaded stud, which is attached to a substrate. A disadvantage of this fastener is that the threaded stud is already gripped by the retaining fingers before the component reaches its final position on the substrate. This impedes subsequent alignment of the component. Insertion of the threaded stud into the fastener is also difficult here, because the threaded stud is hidden by the component and the flange of the fastener.

Known from EP 0,566,296 B1 is a plastic “pushbutton” fastener for fastening a trim strip or a body panel to a motor vehicle body, which has a cylindrical shank with retaining fingers arranged therein for gripping a threaded stud. Molded on the rear end of the shank in the direction of installation is a flat, circular retaining head, and the other end of the shank has a skirt that opens conically outward in the direction of installation and has multiple clamps on its circumferential edge by means of which the pushbutton can be anchored in a mounting hole of the component to be fastened for preassembly. In the preassembly position of the pushbutton thus attained, the component can initially be aligned in the assembly position and then be permanently fastened by pressing the pushbutton fully into the assembly hole and pressing onto the threaded stud. A disadvantage of this fastener is that, in the fastening position, the head is a considerable distance from the surface onto which the threaded bolt is welded. The component to be fastened must therefore have a special curvature if it is to contact the head in the fastening position.

The object of the invention is to produce a fastener of the initially mentioned type which can be preinstalled on the item to be fastened and which in the preassembled position facilitates placement and alignment of the item to be fastened. Furthermore, it should be possible to join the fastener with a threaded stud manually without the use of tools.

The object is attained by the invention set forth in claim 1. Advantageous embodiments of the invention are set forth in the dependent claims.

In accordance with the invention, the flange of the fastener, which can be pressed against the item to be fastened, is arranged a distance away from the retaining element and attached to the retaining element by means of spring shackles. In this way, the flange can be preinstalled on the item to be fastened, while the retaining element, held by the spring shackles, remains a distance from the item to be installed that can be dimensioned great enough that the threaded stud projecting through the assembly hole and the flange during installation of the item on a substrate is not yet gripped by the clamping element. Consequently, the item to be installed can first be aligned and moved as needed without the fastener locking on the threaded stud and thereby hindering or preventing movement for the purpose of alignment. Premature locking of the fastener onto the wrong place is thus avoided. Once alignment has been accomplished, the fastener can be manually pressed onto the threaded stud, causing the spring shackles to be elastically deformed and press the flange against the item with the spring force thus accentuated. In this context, the spring shackles are designed such that their deformation by hand is easily possible.

The inventive fastener further has the advantage that the distance between the flange and the retaining element creates a free space through which the opening of the flange is clearly visible. This facilitates positioning of the flange relative to a threaded stud, since the stud behind the component can be seen better through the opening in the flange.

According to a further proposal of the invention, provision is made that the flange has a greater radial extent than the forward end of the retaining element, and that the spring shackles extend from the retaining element radially outward, curve by approximately 90°, then extend to the back of the flange facing the retaining element. This design fosters deformation of the spring shackles and permits direct contact between the retaining element and the flange in the fastening position, so that the retention forces can be transmitted directly to the flange.

It has proven to be sufficient and advantageous if at least two spring shackles are provided in a symmetrical arrangement opposite one another. In this way, the fastener is simple to produce and the symmetrical arrangement of the spring shackles ensures that the retaining element maintains its centered position relative to the flange when it is pressed onto the flange. In a departure from this design, more than two spring shackles can of course also be provided, however. Joining the retaining element to the flange by just one spring shackle is also possible, but this requires somewhat more dexterity when pressing the retaining element onto a threaded stud.

Low insertion force in combination with secure anchoring of the retaining element on a threaded stud is achieved according to another proposal of the invention in that the inner diameter of the cavity is greater than the outer diameter of the threaded stud and in that the retaining element has retaining fingers extending into the cavity that are angled with respect to the longitudinal axis of the retaining element such that they diverge further from the wall of the cavity with increasing distance from the forward end of the retaining element. For improved adhesion, the retaining fingers may have at their free ends teeth which engage the thread grooves of the threaded stud.

The introduction of a threaded stud into the cavity of the retaining element is made easier by a design in which the entry opening of the cavity widens conically, with the diameter increasing toward the outside.

According to another proposal of the invention, the retaining element can have a polygonal, more particularly hexagonal, outer contour. This makes it possible to rotate the fastener with the aid of a wrench, so that it may be released again after being fastened to a threaded stud. The rear end of the retaining element in the direction of installation may have a closed end, in particular likewise polygonal or hexagonal, which helps to reinforce the retaining element, in particular for unscrewing.

The flange of the fastener is ring-shaped and has a central opening that is smaller than the radial extent of the retaining element, wherein its back forms a contact surface for the forward end of the retaining element. Preferably the flange is designed in the manner of a spring washer in order to be able to induce a spring preloading between the retaining element and the item to be fastened. In order to achieve the desired spring effect, the flange can have a reinforced circumferential edge and multiple slots extending essentially radially from the opening toward the circumferential edge. By this means, a flat characteristic spring curve can be achieved.

Unfavorable deformation of the spring shackles during unscrewing of the fastener is avoided according to another proposal of the invention in that coupling elements and mating coupling elements are arranged on the flange and also on the end of the retaining element facing the flange, which engage in one another and prevent rotation of the flange relative to the retaining element when the flange rests against the retaining element in the assembled state of the fastener. The coupling elements can be composed of axial projections on the flange, and the mating coupling elements can be composed of recesses in the retaining element that accommodate the projections.

To secure the clamping element against loosening, the flange can have an anti-rotation feature that, in cooperation with the component to be fastened, produces rotational resistance.

The fastener is preferably made of plastic in one piece. To this end, the retaining element is provided with lateral openings for the mold cores to produce the retaining fingers.

The invention is explained in detail below on the basis of an example embodiment shown in the drawing. The drawings show:

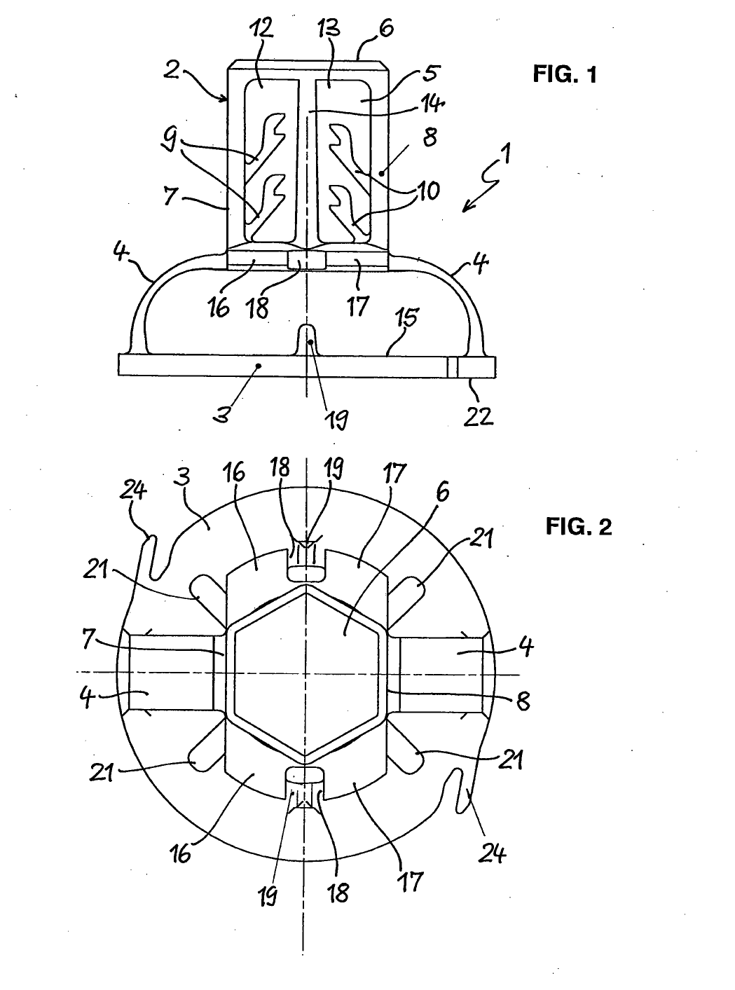

FIG. 1 a side view of a fastener according to the invention,

FIG. 2 a top view of the fastener from FIG. 1,

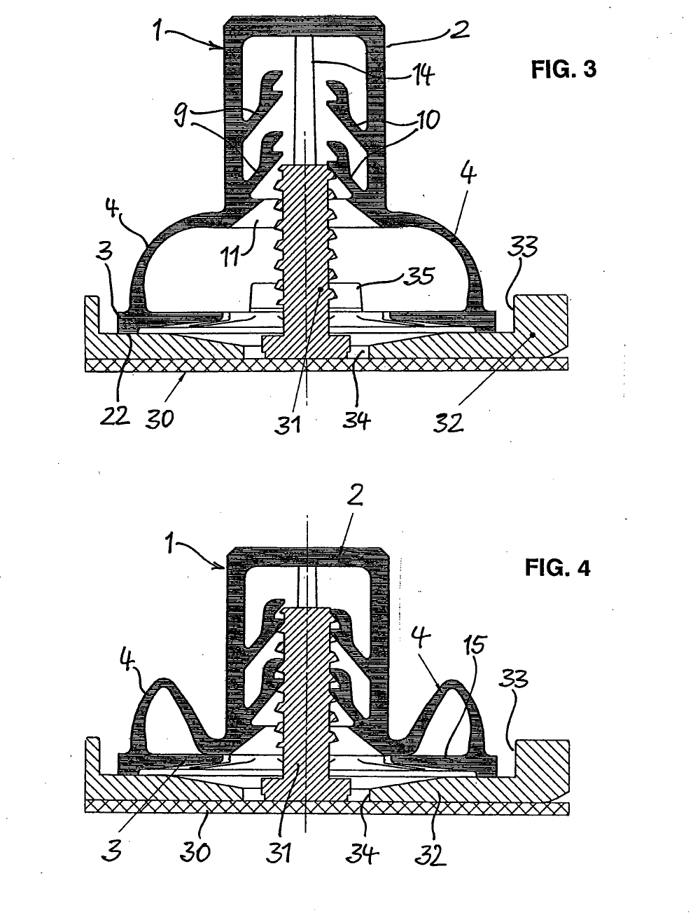

FIG. 3 a cross-section through a fastening assembly using the fastener from FIG. 1 in the pre-installation position,

FIG. 4 a cross-section through the fastening assembly from FIG. 3 in the final installed position.

The fastener 1 shown in the drawings consists of a retaining element 2 and a flange 3, which are joined to one another by spring shackles 4. The retaining element 2 is in the shape of a sleeve with a hexagonal cross-section that encloses a cavity 5, which likewise is hexagonal in cross-section, and is closed at one end by a hexagonal end 6. Applied to each of two opposing walls 7, 8 of the cavity 5 are two retaining fingers 9, 10, which extend at an angle of approximately 45° to the longitudinal axis of the retaining element 2 into the cavity 5 and toward the end 6. At their free ends, the retaining fingers 9, 10 each have two teeth that have an appropriate separation for engaging in the thread grooves of a threaded stud. The retaining fingers 9 are offset in the axial direction by half the pitch height of the associated stud thread relative to their opposing retaining fingers 10. The end of the retaining element 2 opposite the end 6 is provided with a conical opening 11 that widens toward the flange 3, see FIG. 3. On both sides of the walls 7, 8, the retaining element 2 has rectangular openings 12, 13 that serve to accommodate mold cores during manufacture of the fastener. A web 14 parallel to the axis, located at one corner of the hexagonal cross-section, separates the openings 12, 13 from one another. A second web 14 is located in a mirror-image arrangement on the rear of the fastener, which is not visible in FIG. 1.

The spring shackles 4 are molded on opposite sides on the outside at the open end of the retaining element 2, and extend in a mirror-image arrangement from the retaining element 2 approximately along a quarter-circle toward the outside and forward in the direction of installation so that their ends molded onto the flange 3 intersect approximately perpendicularly with the flat rear 15 of the flange 3. The spacing between the retaining element 2 and the flange 3 is thus approximately equal to the radius of curvature of the spring shackles 4. On both sides of the spring shackles 4, the retaining element 2 has projections 16, 17 extending radially outward, which are intended to support the retaining element 2 on the rear 15 of the flange 3. Located between the projections 16, 17 in each case is a recess 18 which serves as a coupling element. The recesses 18 work together with catch pins 19 that is [sic] located on the rear 15 of the flange 3 and form mating coupling elements. As the retaining element 2 approaches the flange 3, the catch pins 19 enter the recesses 18, thereby facilitating the transmission of a torque between the retaining element 2 and the flange 3.

The flange 3 has a central opening 20 whose diameter is approximately equal to the distance between opposite side faces (width across flats) of the retaining element 2. From the opening 20, four slots 21 extend outward to approximately half the radial width of the flange 3. The slots 21 increase the elastic resilience of the inner circumferential edge of the flange 3. The flange 3 also has a reinforced circumferential edge 23, which forms a raised contact surface 22 on the front of the flange 3 facing away from the retaining element 2. Fingers 24 are molded on the flange 3 at two opposite points on the circumferential edge 23, extending approximately tangentially over the circumferential edge 23 for the purpose of securing the flange 3 against rotation.

FIGS. 3 and 4 show a fastening assembly using the fastener 1. A threaded stud 31 is fastened by welding to a substrate 30 of sheet metal, for example a body part of a motor vehicle. A cover panel 32, for example an underfloor, has a recess 33 at a fastening location that works together with the threaded stud 31 and has an opening 34 in this recess through which the threaded stud 31 is inserted. To prepare for assembly, the flange 3 of the fastener 1 is placed in the recess 33 of the cover panel 32 and snaps in place by means of retaining elements 35, which are provided on the cover panel 32 and engage around the outer edge of the flange 3. The snap-in connection at the retaining elements 35 is designed in such a manner, and the recess 33 is dimensioned large enough, that the flange 3 can be moved in the radial direction relative to the cover panel 32 to compensate for dimensional variations.

After pre-installation of the fastening element 1 on the cover panel 32, the cover panel 32 is placed in its fitting position on the substrate 30, in which it rests against the substrate 30 as shown in FIG. 3. Here, the threaded stud 31 projects through the opening 34 in the cover panel 32 and the openings 20 and 11 in the fastener 1. The length of the threaded stud 31 and the spacing of the retaining fingers 9, 10 of the retaining element 2 from the contact surface 22 of the flange 3, as well as the thickness of the section of the cover panel 32 located between the flange 3 and the substrate 30, are matched to one another such that the threaded stud 31 cannot be gripped by and held in place by the retaining fingers 9, 10, however. Thus, in this assembly situation, the cover panel 32 can be moved relative to the substrate 30 for correct placement, and can if necessary be removed from the substrate 30 again in order to facilitate correct alignment.

Once the desired position of the cover panel 32 is achieved, it is fastened to the threaded stud 31 by manually pushing the retaining element 2 onto the threaded stud 31, thereby bringing it into the position shown in FIG. 4. In this process, the inner ends of the spring shackles 4 bend downward, and the forward end of the retaining element 2 and the projections 16, 17 come into contact with the rear 15 of the flange 3. As the threaded stud 31 enters the retaining element 2, the retaining fingers 9, 10 are pushed apart and snap over the individual thread peaks until their teeth finally latch into the thread grooves of the threaded stud 31 in the final fastening position and secure the retaining element 2 on the threaded stud 31. The spring shackles 4, which are more sharply curved in the fastening position, generate an axial spring force directed toward the flange 3, by which the flange 3 is pressed against the cover panel 32. In addition, during assembly, the retaining element 2 can be brought still closer to the cover panel 32 than is shown in FIG. 4, elastically deforming the flange 3 as well and thereby increasing the contact force. In this way, the fastening assembly remains under elastic preloading in the fastening position and is thereby secured against vibration and rotation. Additional protection against rotation is achieved by the fingers 23, which dig into the edge of the recess 33.

In the fastening position, the catch pins 19 on the flange 3 engage in the recesses 18 on the retaining element 2, and thereby secure the retaining element 2 against rotation with the aid of the flange 3, even if the spring shackles 4 should be destroyed by external action, for example being struck by stones.

The fastening assembly can be removed by rotating the retaining element 2 with a wrench. The torque here is transmitted to the flange 3 through the catch pins 19 engaging in the recesses 18, in which process the limiting action of the fingers 23 must also be overcome.

As a result of the design of the retaining element, the fastener described makes possible a low assembly force but high pull-off forces, since the retaining fingers wedge against the threaded stud under loading in the release direction. The spring shackles ensure that the retaining element is always located in the correct position prior to assembly. After unscrewing of the fastening element which has been pushed into the fastening position, the spring shackles return to their initial position and once again facilitate simple installation. With the aid of the spring shackles and the elastic deformability of the flange, a comparatively high contact force can be produced during assembly which protects the fastening assembly from the effects of vibration.

1. Fastener for application to a threaded stud, having a sleeve-like retaining element with a cavity extending in the direction of its longitudinal axis to accommodate the threaded stud and at least one deformable clamping region that tends to assume a clamping position projecting into the cavity and gripping the threaded body, and having a flange arranged at the forward end of the retaining element in the direction of installation that can be pressed onto an item to be fastened, characterized in that the flange is arranged a distance away from the retaining element and attached to the retaining element by means of spring shackles.

2. Fastener according to claim 1, characterized in that the flange has a greater radial extent than the forward end of the retaining element, and in that the spring shackles extend from the retaining element radially outward, curve by approximately 90°, then extend toward the flange.

3. Fastener according to claim 1, characterized in that the spring shackles are attached to the rear of the flange [sic] facing the retaining element.

4. Fastener according to one of the claim 1, characterized in that the retaining element has retaining fingers extending into the cavity that are angled with respect to the longitudinal axis of the retaining element such that they diverge further from the wall of the cavity with increasing distance from the forward end of the retaining element.

5. Fastener according to claim 4, characterized in that the free ends of the retaining fingers have teeth for engaging in thread grooves of a threaded stud.

6. Fastener according to claim 1, characterized in that the entry opening of the cavity widens conically, with the diameter increasing toward the outside.

7. Fastener according to claim 1, characterized in that the retaining element has a polygonal, more particularly hexagonal, outer contour.

8. Fastener according to one of the claim 1, characterized in that the rear end of the retaining element in the direction of installation has a closed, in particular polygonal or hexagonal, end.

9. Fastener according to claim 1, characterized in that the flange is ring-shaped and has a central opening that is smaller than the radial extent of the retaining element, wherein the back of the flange forms a contact surface for the forward end of the retaining element.

10. Fastener according to claim 1, characterized in that the flange is designed in the manner of a spring washer which can be elastically preloaded in the fastening position between the retaining element and the item to be fastened.

11. Fastener according to claim 1, characterized in that the flange has a reinforced circumferential edge and multiple slots extending essentially radially from the opening toward the circumferential edge.

12. Fastener according to claim 1, characterized in that coupling elements and mating coupling elements are arranged on the flange and also on the end of the retaining element facing the flange, which engage in one another and prevent rotation of the flange relative to the retaining element when the flange rests against the retaining element in the assembled state of the fastener.

13. Fastener according to claim 12, characterized in that the coupling elements are composed of catch pins on the flange, and the mating coupling elements are composed of recesses that accommodate the catch pins in the flange of the retaining element.

14. Fastener according to claim 1, characterized in that it is made of plastic in one piece.

15. Fastening assembly having a fastener according to one of the preceding claims claim 1, having a substrate with a threaded stud welded thereto, and having a component to be fastened to the substrate by means of the fastener, wherein the component has an opening that is greater than the diameter of the threaded stud, wherein the flange of the fastener is retained on one side of the component with limited movability oriented essentially concentrically to the opening, and wherein the spacing of the deformable clamping region of the fastener from the contact surface of the component facing the substrate is greater than the length of the threaded stud.

16. Fastening assembly according to claim 15, characterized in that the inside diameter of the cavity of the fastener is greater than the outer diameter of the threaded stud.

17. Fastening assembly according to claim 15, characterized in that the flange of the fastener has an opening that is the same size as or larger than the opening in the component.
